(19) United States
(12) Patent Application Publication
(10) Pub. No.: US 2009/0039295 A1
(43) Pub. Date: Feb. 12, 2009

(54) DETACHABLE INNER SHIELD

(75) Inventors: Hung-Pin Yu, Taichung County (TW); Hsueh-Li Chiang, Taichung City (TW); Cheng-Da Wu, Keelung City (TW); Shiu-Shien Hsheng, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: PROMOS TECHNOLOGIES INC., Hsinchu (TW)

(21) Appl. No.: 12/033,892

(22) Filed: Feb. 20, 2008

(30) Foreign Application Priority Data
Aug. 7, 2007 (TW) 96129014

(51) Int. Cl. G21F 3/00

(52) U.S. Cl. 250/515.1

(57) ABSTRACT

A detachable inner shield suitable for an isolation bushing of an ion implanter is provided. The inner shield is mounted on an inside of the isolation bushing and completely fitting the inside of the isolation bushing.

### CROSS-REFERENCE TO RELATED APPLICATION

This application claims the priority benefit of Taiwan application serial no. 96129014, filed on Aug. 7, 2007. The entirety of the above-mentioned patent application is hereby incorporated by reference herein and made a part of this specification.

### BACKGROUND OF THE INVENTION

1. Field of the Invention

The present invention is related to a component of an ion implanter, and particularly to a detachable inner shield.

2. Description of Related Art

The ion implantation process is the primary dopant pre-deposition technique in a fabricating process of the very large scale integrated circuit. Its principle is first ionizing dopant and then injecting directly the ionized dopant into silicon chips to pre-deposit the dopant by accelerating ions with an accelerator. Since when an ion implantation process is utilized to perform a dopant pre-deposition process, a concentration of the pre-deposited dopant can be controlled through a current input in an ion beam. A distribution of the pre-deposited dopant inside the doped chip can also be adjusted by energy obtained from accelerating the ions. Therefore, engineers may precisely control the concentration and distribution of dopant inside the chip. Exactly because of this factor, the conventional method of performing dopant pre-deposition by a thermal diffusion process is gradually replaced with an ion implantation process.

An ion implanter is a semiconductor fabrication apparatus having a huge volume and a complicated structure and may be utilized to perform an ion doping process. According to a concentration of the doped ions provided by an implanter, current implanters in mass production are mainly classified into high current implanters and medium current implanters, respectively representing ion beams of about 10 mA and +1 mA. Primary components of the whole ion implanter include: an ion source used for generating ions; a mass analyzer used for separating main dopant ions; and an accelerator used for accelerating implanted ions. Besides the three main components, a general ion implanter further includes a focuser used for focusing ion beams; a scanner used for aiding the ion beams in performing an implantation process on a whole chip; some subsidiary gas supply apparatuses; a vacuum system; a mounting and dismounting system of chips, and so forth.

The basic principle of an ion source device is utilizing plasma to ionize gas atoms by bombarding electrons under a suitable low pressure. In brief, plasma is utilized to generate dopant ions required by the implanter. The dopant ions are located in a source chamber of the ion source device. Electric fields are generated between the source chamber and an extractor when a high voltage is applied to the extractor, and the dopant ions are driven by the electric fields and then extracted.

An isolation bushing is disposed between the source chamber and the extractor to electrically isolate the source chamber from the extractor effectively. However, after the ion implanter is operated for a period of time, the ionized dopant is coated on an inner surface of the isolation bushing, and current leakage occurring in the source chamber and the extractor would lower the efficiency of the ion implanter. Therefore, the isolation bushing needs to receive preventive maintenance regularly.

The conventional method of cleansing the isolation bushing is first dismounting the isolation bushing, then scrubbing it clean with a scrubber dipped in H₂O₂, and finally mounting the isolation bushing back on. However, the isolation bushing is quite heavy (about 25 kilograms) and has a very large volume (a diameter thereof about 70 centimeters). Furthermore, a working space for mounting and dismounting the isolation bushing is very small, only enough space for a single person to do the mounting and dismounting. Therefore, it happens quite often that the isolation bushing falls off and thus working staff gets hurt and the isolation bushing is damaged and broken.

Moreover, a material of the isolation bushing is ceramic. Utilizing H₂O₂ to scrub the isolation bushing would damage the isolation bushing such that a life span of the isolation bushing is reduced and a fabricating cost thereof is increased.

In addition, when the staff doing preventive maintenance is manually scrubbing the isolation bushing with H₂O₂, toxic substances with foul smell are released, which causes damages to health of the preventive maintenance staff.

In another aspect, the mounting and dismounting of the isolation bushing is rather time-consuming and takes about one hour. When the isolation bushing is mounted, it is likely to generate a deviation such that phenomena of current leakage and unstable currents arise in the ion implanter.

### SUMMARY OF THE INVENTION

Accordingly, the present invention is directed to a detachable inner shield which facilitates preventive maintenance.

The present invention is directed to another detachable inner shield which can effectively prevent current leakage from occurring between a source chamber and an extractor.

The present invention provides a detachable inner shield suitable for an isolation bushing of an ion implanter. The inner shield is mounted on an inside of the isolation bushing and completely fitting the inside of the isolation bushing.

According to one preferred embodiment of the present invention, in the detachable inner shield, a surface of the inner shield front-facing the inside of the isolation bushing includes at least one trench.

According to one preferred embodiment of the present invention, in the detachable inner shield, a material of the inner shield is, for example, Teflon.

According to one preferred embodiment of the present invention, in the detachable inner shield, a weight of an inner shield is smaller than that of the isolation bushing.

According to one preferred embodiment of the present invention, in the detachable inner shield, when the inner shield is mounted on the inside of the isolation bushing, no additional fixing device is required.

According to one preferred embodiment of the present invention, in the detachable inner shield, a surface of the inner shield back-facing the inside of the isolation bushing includes a protrusive part and the isolation bushing includes a depression part. The protrusive part engages with the depression part.

The present invention provides another detachable inner shield suitable for an isolation bushing of an ion implanter. The inner shield includes a plurality of shielding plates mounted on an inside of the isolation bushing and completely fitting the inside of the isolation bushing.

According to another preferred embodiment of the present invention, in the detachable inner shield, a surface of each of the shielding plates front-facing an inside of the isolation bushing includes at least one trench.

According to another preferred embodiment of the present invention, in the detachable inner shield, a material of the shielding plate is, for example, Teflon.

According to another preferred embodiment of the present invention, in the detachable inner shield, a total weight of the shielding plates is smaller than a weight of the isolation bushing.

According to another preferred embodiment of the present invention, in the detachable inner shield, when the shielding plates are mounted on the inside of the isolation bushing, no additional fixing device is required.

According to another preferred embodiment of the present invention, in the detachable inner shield, a surface of each of the shielding plates back-facing the inside of the isolation bushing includes a protrusive part, and the isolation bushing includes a depression part. The protrusive part engages with the depression part.

In light of the aforementioned, since the detachable inner shield of the present invention is mounted on the inside of the isolation bushing, when a preventive maintenance operation is performed, instead of the isolation bushing, only the inner shield needs to be dismounted, and injuries caused to the working staff and damages done to the isolation bushing because the isolation bushing falls off can both be avoided. Consequently, reduced efficiency of the ion implanter resulted from deviation during the mounting of the isolation bushing is prevented.

In another aspect, the detachable inner shield of the present invention can be easily and quickly mounted and dismounted. Furthermore, there is no need to dismount the isolation bushing and thereby reducing a period for performing preventive maintenance. Additionally, when cleansing the inner shield, the dismounted inner shield may be directed placed in a cleansing tank to be cleansed, which prevents the preventive maintenance staff from inhaling toxic substances and causing damages to the health of the staff, and further prevents a cleansing solution from damaging the isolation bushing and thereby reducing a fabricating cost of changing the isolation bushing.

Moreover, when a surface of the detachable inner shield of the present invention has a trench, a path of the current leakage is extended and a thickness of dopant coating is reduced and thereby reducing a cross-section area of the current leakage, minimizing damages of the current leakage and thus effectively improving efficiency of the ion implanter.

Besides, when a material difficult to be eroded by the cleansing solution is utilized to fabricate the detachable inner shield of the present invention, a fabricating cost of the detachable inner shield is effectively lowered.

Further, when the detachable inner shield of the present invention is mounted in the inside of the isolation bushing, no additional fixing device is required to be utilized to fix it and thereby rendering the mounting of the inner shield even more convenient.

In order to make the aforementioned and other objects, features and advantages of the present invention more comprehensible, preferred embodiments accompanied with figures are described in detail below.

### BRIEF DESCRIPTION OF THE DRAWINGS

FIG. 1 illustrates a schematic view of a conventional isolation bushing.

FIG. 2 illustrates a schematic view of an inner shield according to one embodiment of the present invention.

FIG. 3 illustrates a schematic view of an upper surface and an lower surface of the component in FIG. 2.

FIG. 4 illustrates a schematic view of mounting the inner shield of FIG. 2 to the isolation bushing of FIG. 1.

### DESCRIPTION OF EMBODIMENTS

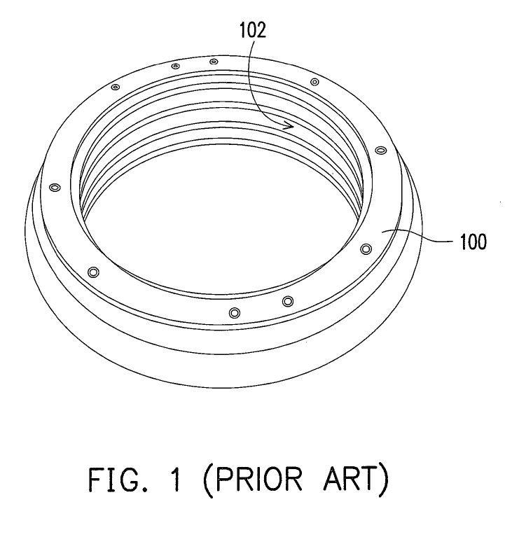

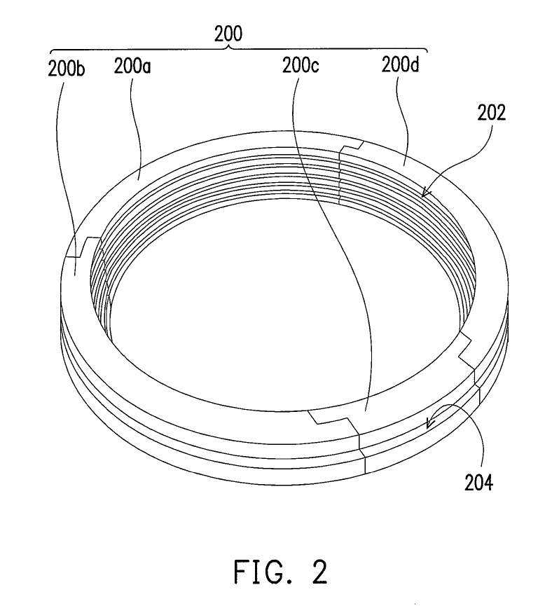

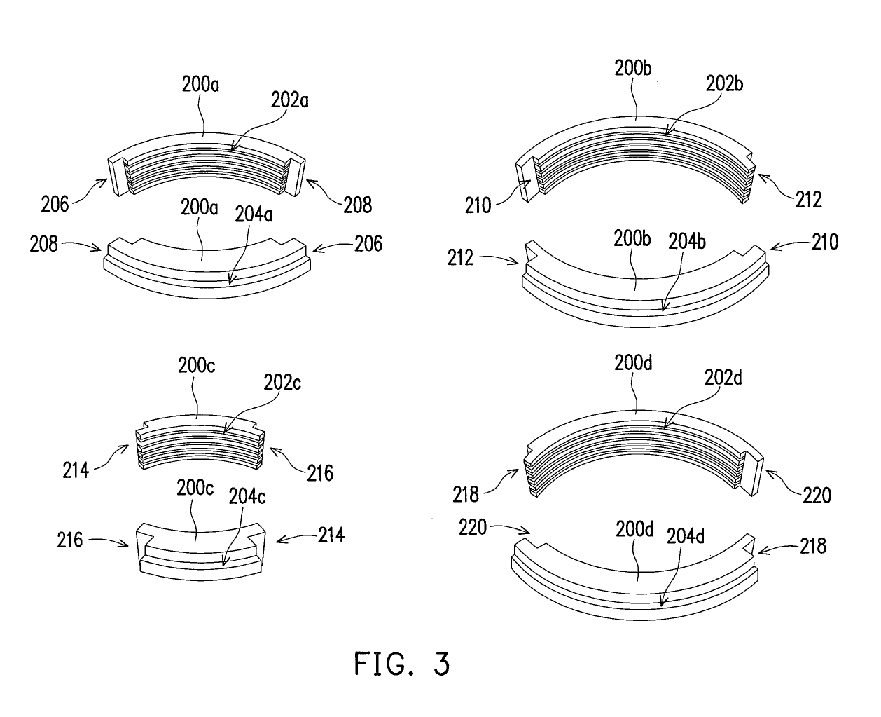

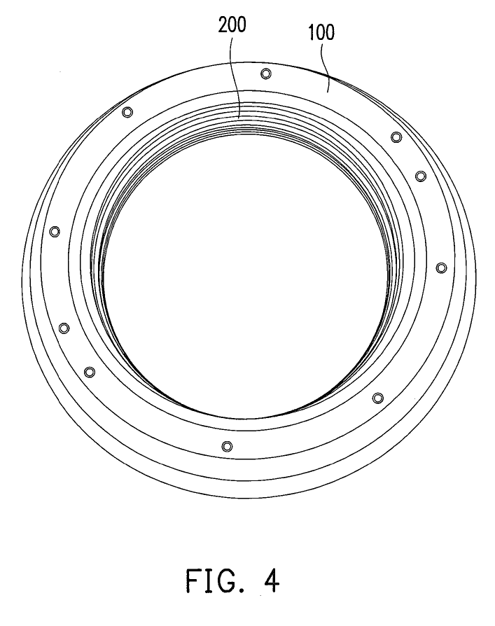

FIG. 1 illustrates a schematic view of a conventional isolation bushing. FIG. 2 illustrates a schematic view of an inner shield according to one embodiment of the present invention. FIG. 3 illustrates a schematic view of an upper surface and an lower surface of the component in FIG. 2. FIG. 4 illustrates a schematic view of mounting the inner shield of FIG. 2 to the isolation bushing of FIG. 1.

Referring to FIGS. 1, 2, 3, and 4, an inner shield 200 is adapted for an isolation bushing 100 of an ion implanter (not illustrated). The inner shield 200 is mounted on an inside of the isolation bushing 100 and completely fitting the inside of the isolation bushing 100 so as to prevent the isolation bushing 100 from being polluted by dopant.

Since the inner shield 200 is mounted in the isolation bushing 100, when a preventive maintenance is performed, the heavy isolation bushing 100 is not required to be dismounted and only the inner shield 200 needs to be dismounted. Therefore, the situation that staff gets injured and the isolation bushing 100 is damaged because the isolation bushing 100 falls off would not happen. Lowered efficiency of the ion implanter resulted from deviation occurring during the mounting of the isolation bushing 100 can be prevented.

Additionally, when cleansing the inner shield 200, the dismounted inner shield 200 can be directly placed in a cleansing tank to be cleansed, which prevents the preventive maintenance staff from inhaling toxic substances generated during the cleansing of the inner shield 200 and thereby avoiding damages to health of the preventive maintenance staff. Furthermore, when performing preventive maintenance, there is no need to dismount the isolation bushing 100 to be scrubbed clean with a cleansing solution, and thus damages to the isolation bushing 100 caused by the cleansing solution can be avoided and thereby reducing a fabricating cost.

In the present embodiment, the inner shield 200 is a circular structure constituted by four shielding plates 200a, 200b, 200c and 200d. Any material difficult to be eroded by the cleansing solution may be utilized to fabricate the shielding plates 200a, 200b, 200c and 200d. For example, when the cleansing solution used to perform a preventive maintenance operation on the inner shield 200 is hydrogen peroxide, a material constituting the shielding plates 200a, 200b, 200c and 200d of the inner shield 200 is Teflon, for example. In addition, a total weight of the shielding plates 200a, 200b, 200c and 200d of the inner shield 200 is, for example, smaller than a weight of the isolation bushing 100. Since a weight of the inner shield 200 is light (such as 1.5 kilograms), the light weight facilitates mounting and dismounting the inner shield.

Moreover, surfaces of the shielding plates 200a, 200b, 200c and 200d front-facing an inside of the isolation bushing 100 have, for example, trenches 202a, 202b, 202c and 202d respectively. As a result, a surface of the inner shield 200 front-facing the inside of the isolation bushing 100 has a trench 202. In the present embodiment, a surface of the inner shield 200 has five trenches 202, but people of ordinary skill in the art may adjust a number of the trenches according to actual requirements. When the surface of the detachable inner shield 200 has trenches 202, even if dopant is coated on the surface of the inner shield 200, a path route of current leakage can also be extended by the trenches 202 and a thickness of the dopant coating can be reduced and thereby reducing a cross-section area of the current leakage, minimizing damages caused by the current leakage and effectively improving efficiency of the ion implanter.

Further, surfaces of the shielding plates 200a, 200b, 200c and 200d back-facing the inside of the isolation bushing 100 have, for example, protrusive parts 204a, 204b, 204c and 204d. Consequently, a surface of the inner shield 200 back-facing the inside of the isolation bushing 100 has a protrusive part 204, and the isolation bushing 100 has, for example, a depression part 102. The protrusive part 204 engages with the depression part 102. When the inner shield 200 is mounted on the inside of the isolation bushing 100, the protrusive part 204 helps fix the isolation bushing 200 on the inside of the isolation bushing 100.

It should be noted that when the inner shield 200 constituted by the shielding plates 200a, 200b, 200c and 200d is mounted on the inside of the isolation bushing 100, no additional fixing device such as a screw is needed. In the present embodiment, besides that the protrusive part 204 of the inner shield 200 helps fix the inner shield 200 on the inside of the isolation bushing 100, shapes of two ends of the shielding plates 200a, 200b, 200c and 200d also help mount the inner shield 200 on the inside of the isolation bushing 100.

For example, directions of the shielding plates 200a, 200b, 200c and 200d front-facing the inside of the isolation bushing 100 are defined as an upward direction, and a downward direction as the opposite. Two ends 206 and 208 of the shielding plate 200a have a shape with a narrow upper portion and a wide under portion. Two ends 214 and 216 of the shielding plate 200c have a shape with a wide upper portion and a narrow under portion. Two ends 212 and 218 of the shielding plates 200b and 200d close to the shielding plate 200a have a shape with a wide upper portion and a narrow under portion so as to connect with the ends 206 and 208 of the shielding plate 200a respectively. Two ends 210 and 220 of the shielding plates 200b and 200d close to the shielding plates 200c have a shape with a narrow upper portion and a wide under portion so as to connect with the ends 216 and 214 of the shielding plate 200c respectively. Thus, when mounting the inner shield 200, a mounting sequence thereof is first mounting a shielding plate 200a, then mounting the shielding plates 200b and 200d, and finally mounting the shielding plate 200c. Stress generated by connecting the shapes of the ends of the shielding plates 200a, 200b, 200c and 200d can be utilized to fix the inner shield 200 on the inside of the isolation bushing 100. On the contrary, when dismounting the inner shield 200, a dismounting sequence is first dismounting the shielding plate 200c, then dismounting the shielding plates 200b and 200d, and finally dismounting the shielding plate 200a.

Generally, since the mounting and dismounting of the inner shield 200 is very easily operated, the mounting and dismounting of the inner shield 200 only takes a few minutes whereas the mounting and dismounting of the isolation bushing 100 takes about one hour. Therefore, when a preventive maintenance operation is performed, the inner shield 200 can be easily and quickly mounted and dismounted. Besides, the isolation bushing 100 does not need to be dismounted, which reduces a period of performing a preventive maintenance operation.

In the aforesaid embodiment, the inner shield 200 constituted by four shielding plates 200a, 200b, 200c and 200d is taken as an example to facilitate illustration, but it is not intended to limit the present invention. People of ordinary skill in the art may adjust the way in which the inner shield is constituted and the number of shielding plates to meet design requirements with reference to the disclosure of the aforesaid embodiment.

In summary, the present invention has at least the following advantages:

1. The detachable inner shield of the present invention prevents the staff from getting hurt when a preventive maintenance operation is performed on the ion implanter.

2. The detachable inner shield of the present invention can be utilized to effectively prevent current leakage generated between the source chamber and the extractor and thereby preventing the efficiency of the ion implanter from being lowered.

3. The detachable inner shield of the present invention makes the preventive maintenance operation easier and more convenient, and thereby reducing the period thereof.

4. The detachable inner shield of the present invention effectively reduces the fabricating cost.

Although the present invention has been disclosed above by the preferred embodiments, they are not intended to limit the present invention. Anybody skilled in the art can make some modifications and alterations without departing from the spirit and scope of the present invention. Therefore, the protecting range of the present invention falls in the appended claims.

What is claimed is:

1. A detachable inner shield, suitable for an isolation bushing of an ion implanter, the inner shield mounted on an inside of the isolation bushing and completely fitting the inside of the isolation bushing.

2. The detachable inner shield as claimed in claim 1, wherein a surface of the inner shield front-facing an inside of the isolation bushing comprises at least one trench.

3. The detachable inner shield as claimed in claim 1, wherein a material of the inner shield comprises Teflon.

4. The detachable inner shield as claimed in claim 1, wherein a weight of the inner shield is smaller than that of the isolation bushing.

5. The detachable inner shield as claimed in claim 1, wherein when the inner shield is mounted on the inside of the isolation bushing, no additional fixing device is required.

6. The detachable inner shield as claimed in claim 1, wherein a surface of the inner shield back-facing the inside of the isolation bushing comprises a protrusive part, and the isolation bushing comprises a depression part, the protrusive part engaging with the depression part.

7. A detachable inner shield, suitable for an isolation bushing of an ion implanter, the inner shield comprising a plurality of shielding plates mounted on an inside of the isolation bushing and completely fitting the inside of the isolation bushing.

8. The detachable inner shield as claimed in claim 7, wherein a surface of each of the shielding plates front-facing an inside of the isolation bushing comprises at least one trench.

9. The detachable inner shield as claimed in claim 7, wherein a material of the shielding plates comprises Teflon.

10. The detachable inner shield as claimed in claim 7, wherein a total weight of the shielding plates is smaller than a weight of the isolation bushing.

11. The detachable inner shield as claimed in claim 7, wherein when the shielding plates are mounted on the inside of the isolation bushing, no additional fixing device is required.

12. The detachable inner shield as claimed in claim 7, wherein a surface of each of the shielding plates back-facing the inside of the isolation bushing comprises a protrusive part, and the isolation bushing comprises a depression part, the protrusive part engaging with the depression part.
